(19) United States
(12) Patent Application Publication
(10) Pub. No.: US 2013/0042435 A1
(43) Pub. Date: Feb. 21, 2013

(54) HINGE ASSEMBLY

(71) Applicant: Randall T. Schott, Temperance, MI (US)

(72) Inventor: Randall T. Schott, Temperance, MI (US)

(73) Assignee: MIDWAY PRODUCTS GROUP, INC., Monroe, MI (US)

(21) Appl. No.: 13/589,596

(22) Filed: Aug. 20, 2012

Related U.S. Application Data
(60) Provisional application No. 61/525,406, filed on Aug. 19, 2011.

(51) Int. Cl. E05D 3/08; E05D 11/10; E05D 3/12

(52) U.S. Cl. 16/321; 16/368; 16/319

(57) ABSTRACT

A hinge assembly that allows a door to swing open up to approximately 170 degrees, which allows for greater access to the interior compartment. In one embodiment, the hinge assembly includes two mounting brackets, a load link and a driver link. The load link is configured to carry the weight of the door while the driver link drives the load link through the pivoting motion. As the door begins to swing open, the driver link is fixed in association with the load link. This association allows the hinge assembly to rotate and keep a constant between each link, thereby allowing for a smooth and single opening motion.

### RELATED APPLICATIONS

This application claims the benefit of U.S. Provisional Application Ser. No. 61/525,406 filed Aug. 19, 2011, the disclosure of which is hereby incorporated by reference in its entirety.

### TECHNICAL FIELD

The present invention relates generally to hinges for opening a door; in particular, this invention relates to a vehicle hinge that allows a door to be opened almost 180 degrees for easier access to the interior compartment.

### BACKGROUND AND SUMMARY

Hinges allow the doors of a vehicle to be opened/closed for entry/exit. Typically, hinges are mounted on the front of doors so that the doors swing outwardly away from the vehicle. Most hinges only allow the doors to be opened in a limited range—often having less than a 90 degrees opening range. For some applications, hinges have been devised that mount to the rear of doors and allow for a wider opening range. Typically, this type of hinge uses multiple stages to increase the opening range. Unfortunately, these multiple stage hinges have an overly complex design. There exists a need for a hinge that has a greater opening range than 90 degrees that does not require multiple stages.

According to one aspect, the invention provides a hinge assembly that allows a door to swing open up to approximately 170 degrees, which allows for greater access to the interior compartment. In one embodiment, the hinge assembly includes two mounting brackets, a load link and a driver link. The load link is configured to carry the weight of the door while the driver link drives the load link through the pivoting motion. As the door begins to swing open, the driver link is fixed in association with the load link. This association allows the hinge assembly to rotate and keep a constant between each link, thereby allowing for a smooth and single opening motion.

In some exemplary embodiments, an axis about which the first end of the load link pivots is fixed with respect to an axis about which the first end of the driver link pivots. In some cases, the axis about which the second end of the load link pivots is fixed with respect to the axis about which the second end of the driver link pivots. For some embodiments, the first end of the load link and the first end of the driver link have a gooseneck shape.

Embodiments are contemplated in which the first end of the load link has at least two points of pivotal connection with the door bracket. Likewise, in some embodiments, the second end of the load link has at least two points of pivotal connection with the body bracket. In some cases, the axis about which the first end of the load link pivots is closer to the vehicle door than the axis about which the first end of the driver link pivots. In some embodiments, the axis about which the second end of the driver link pivots is closer to the vehicle body than the axis about which the second end of the load link pivots.

In some exemplary embodiments, the door bracket includes a generally U-shaped portion with a first door bracket leg spaced apart from a second door bracket leg with both legs extending from a door bracket bridge member. Typically, one or more flanges extend from the U-shaped portion of the door bracket for attachment to a vehicle door. In some cases, the body bracket may include a generally U-shaped portion with a first body bracket leg spaced apart from a second body bracket leg with both legs extending from a body bracket bridge member. The U-shaped portion of the body bracket may have one or more flanges for attachment to a vehicle body. Embodiments are contemplated in which the load link has a first end pivotally coupled with the first door bracket leg and the second door bracket leg of the door bracket and a second end pivotally coupled with the first body bracket leg and the second body bracket leg of the body bracket. The driver link is typically pivotally coupled with the first door bracket leg and a second end pivotally coupled with the first body bracket leg.

For some embodiments, at least a portion of the first end of the load link is interposed between the first door bracket leg and the second door bracket leg. In some cases, at least a portion of the second end of the load link is interposed between the first body bracket leg and the second body bracket leg. In some exemplary embodiments, the first door bracket leg includes a hole that is aligned with a hole in the second door bracket leg. The first end of the load link may include at least two spaced apart flanges with aligned openings that are aligned with the holes in the first door bracket leg and the second door bracket leg. In some cases, a pin extends through the holes in the first door bracket leg and the second door bracket leg and the openings in the flanges on the first end of the load link. Embodiments are contemplated in which the first body bracket leg includes a hole that is aligned with a hole in the second body bracket leg and the second end of the load link includes at least two spaced apart flanges with aligned openings that are aligned with the holes in the first body bracket leg and the second body bracket leg. In such an embodiment, a pin could be provided that extends through the holes in the first body bracket leg and the second body bracket leg and the openings in the flanges on the second end of the load link.

In some embodiments, a door check assembly is provided that holds the door bracket in a selected position with respect to the load link. For example, the door check assembly may include a pawl pivotally attached to the door bracket and a wheel connected to the load link. A biasing member may be provided to urge the pawl towards the wheel. The biasing member maintains the position of the door bracket with respect to the load link due to the biasing force urging the pawl against the wheel. Embodiments are contemplated in which the wheel includes a circumferential groove that receives the pawl. The pawl may include one or more notches corresponding with selected positions in which to maintain the door bracket with respect to the load link.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is an exploded view of an example hinge assembly according to an embodiment of the present invention;

FIG. 2 is a perspective view of the example hinge assembly shown in FIG. 1 mounted to a door and body of the vehicle with the door in the closed position;

FIG. 3 is a top view of the example hinge assembly shown in FIG. 2;

FIG. 4 is a perspective view of the example hinge assembly shown in FIG. 1 mounted to a door and body of the vehicle with the door partially open;

FIG. 5 is a top view of the example hinge assembly shown in FIG. 4;

FIG. 6 is a perspective view of the example hinge assembly shown in FIG. 1 mounted to a door and body of the vehicle with the door totally open;

FIG. 7 is a top view of the example hinge assembly shown in FIG. 6; and

FIG. 8 is a perspective view of an example hinge assembly according to another embodiment of the present invention with an integrated door check.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

The present invention relates generally to a hinge assembly that may allow opening of a door up to approximately 170 degrees. In some cases, depending on the circumstances, the hinge may be configured to open more than 170 degrees. Although the hinge assembly will be discussed herein with respect to the hinge of a vehicle door, other embodiments are contemplated, such as cabinet doors, tool cases, and other hinge applications.

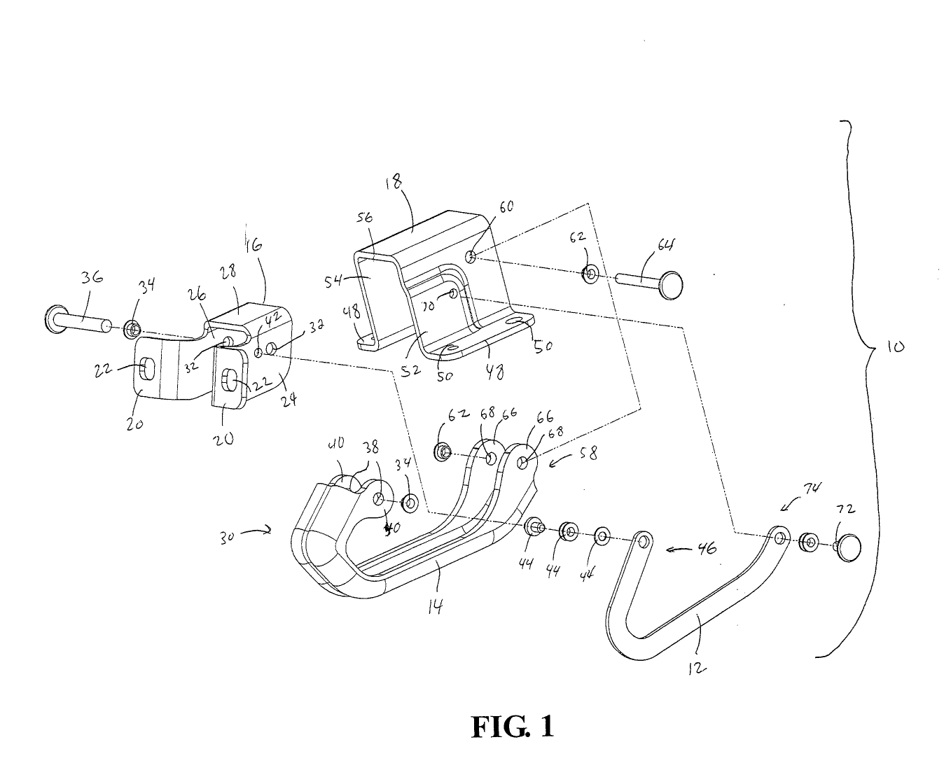

FIG. 1 shows an example embodiment of a hinge assembly 10 according to the invention with a driver link 12 and load link 14 that provide pivotal movement of a door bracket 16 with respect to a body bracket 18 up to approximately 170 degrees. This allows easier access to the interior compartment of the vehicle. In the embodiment shown, the load link 14 is configured to support the weight of the door, while the driver link 12 drives the load link 14 through the pivoting motion. Typically, the load link 14 may be designed to withstand the load of the vehicle door without bending or twisting. In some embodiments, the load link 14 may be configured to withstand the load of the door without regard to the driver link 12. Accordingly, such as in the embodiment shown, the load link 14 may be structurally more substantial than the driver link 12 to withstand stresses applied to the hinge assembly 10 by a vehicle door. One skilled in the art should appreciate that the materials and configuration of the load link 14 may be based on the load of the door and/or structural analysis. Typically, the driver link 12, load link 14, door bracket 16, and body bracket 18 are formed from metal; however often materials, such as plastic, could be used on one or more of the components depending on the circumstances. The components 12, 14, 16, 18 could be adapted, for example, depending on the application to be used on virtually any vehicle door configuration.

In the example shown, the door bracket 16 includes flanges 20 that extend outwardly in a transverse direction. As shown, the flanges 20 include openings 22 for attaching the bracket 16 to a door. One skilled in the art should appreciate that numerous suitable devices or methods could be used to attach the bracket to a door, such as a fastener, adhesive, or welding.

In the example shown, a first leg 24 and a second leg 26 extend from the flanges 20 and are spaced apart by a bridge member 28. In this example, the legs 24, 26 are separated a distance sufficient to receive a first end 30 of the load link 14. The legs 24, 26 define load pin openings 32 dimensioned to receive bushings 34 and a first load pin 36. This allows the first load pin 36 to rotate freely within the bushings 34 to allow pivoting about the first end 30 of the load link 14. As shown, the first load pin 36 is also dimensioned to be received by openings 38 defined in flanges 40 of the load link 14. With this configuration, the load pin openings 32 and the openings 38 of the flanges 40 on the first end 30 of the load link 14 are aligned so the first load pin 36 can pass therethrough. A retaining ring, nut or other fastener could be used to prevent the first load pin 36 from accidentally being removed from the door bracket 16.

In the embodiment shown, the first leg 24 includes a driver pin opening 42 dimensioned to receive connectors 44 for pivotably attaching the first end 46 of the driver link 12. In the example shown, the load link 14 and driver link 12 have a goose-neck shape to allow for the hinge assembly 10 to be opened at least approximately 170 degrees. As discussed above, one skilled in the art should appreciate that the hinge assembly 10 may open more than 170 degrees depending on the obstructions that might limit opening of the doors.

The body bracket 18 includes flanges 48 that extend outwardly in a transverse manner. The flanges 48 include openings for mounting the body bracket 18 to the body of a vehicle. As discussed above, there are several devices and methods for connecting the body bracket 18 to the body of a vehicle that would be within the abilities of one skilled in the art. A first leg 52 and a second leg 54 extend from the flanges 48. The legs 52, 54 are spaced apart and joined by a bridge 56. Typically, the legs 52, 54 are spaced sufficiently to receive a second end 58 of the load link 14.

The legs 52, 54 define load pin openings 60 that are dimensioned to receive bushings 62 and a second load pin 64. This allows the second load pin 64 to rotate freely with respect to the bushing 62. The second end 58 of the load link 14 includes flanges that define openings 68 to receive the second load pin 64. With this configuration, the openings in the flanges 66 and load pin openings 60 can be aligned and the second load pin 64 pass therethrough.

In the embodiment shown, the first leg 52 includes a driver pin opening 70 dimensioned to receive a driver pin 72 for pivotably attaching a second end 74 of the driver link 12 to the body bracket 18.

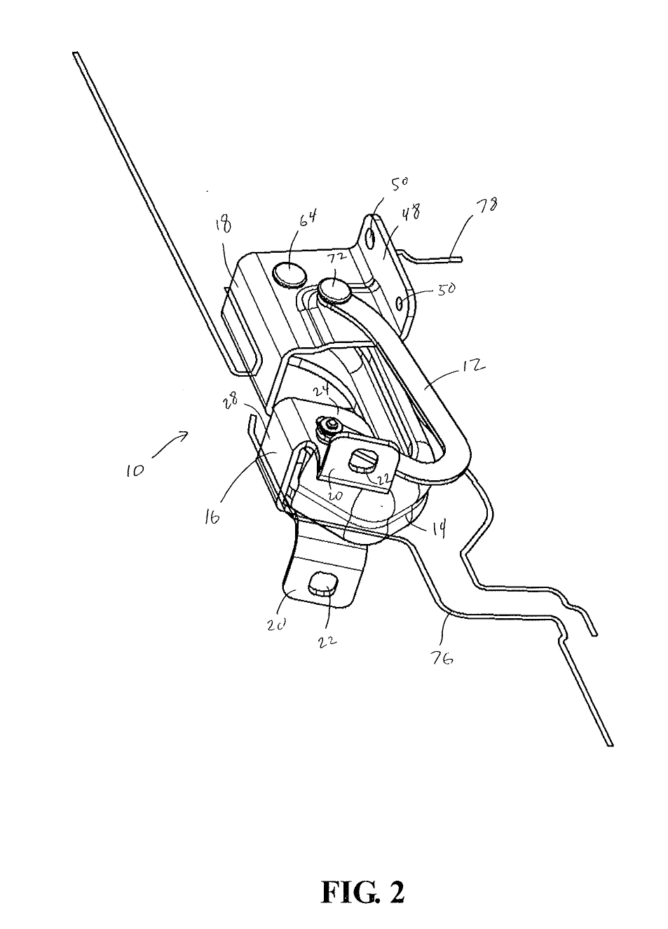

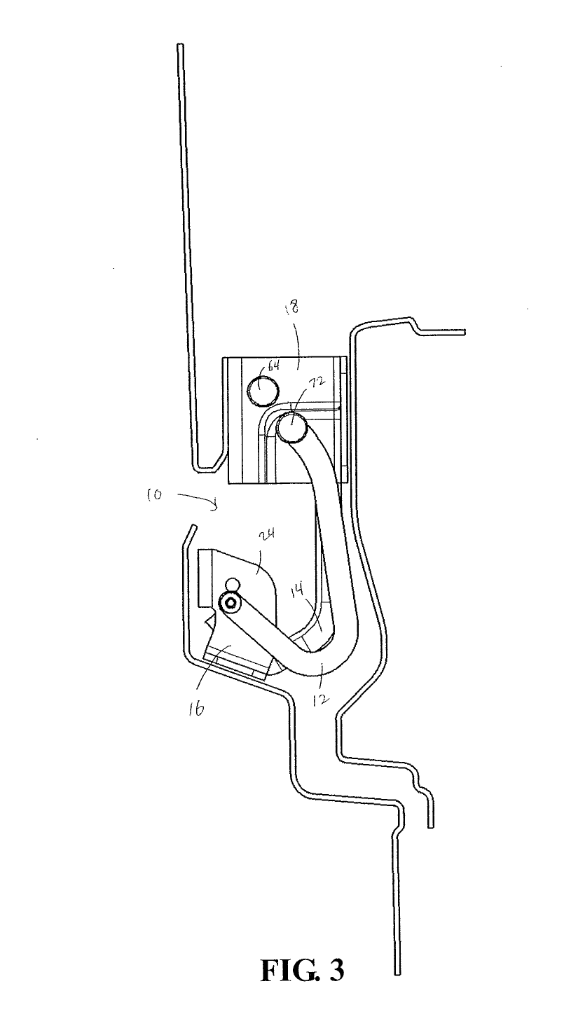

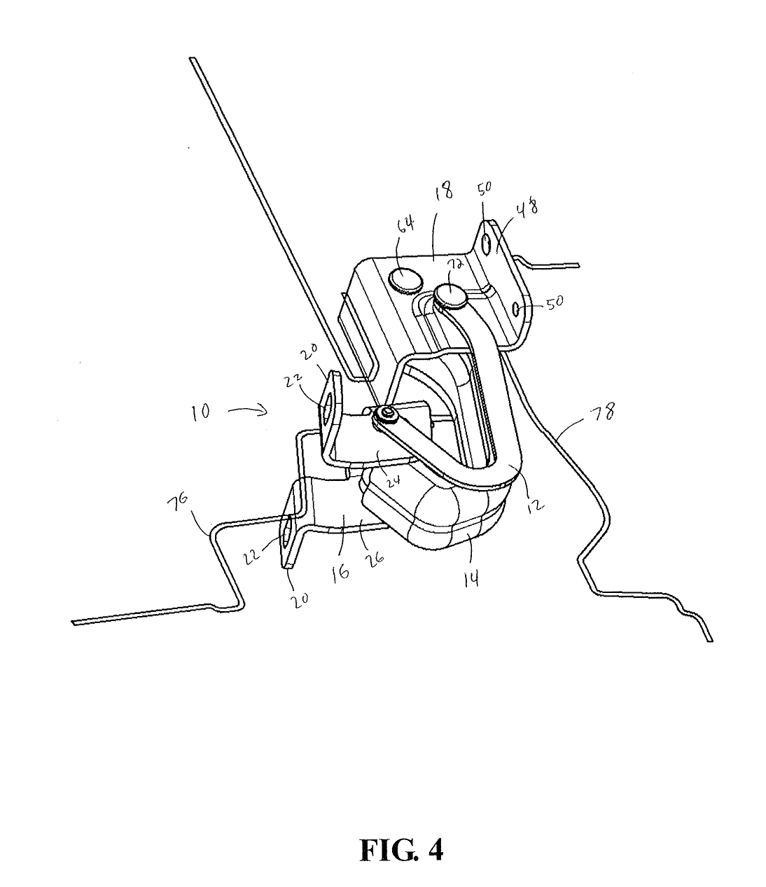

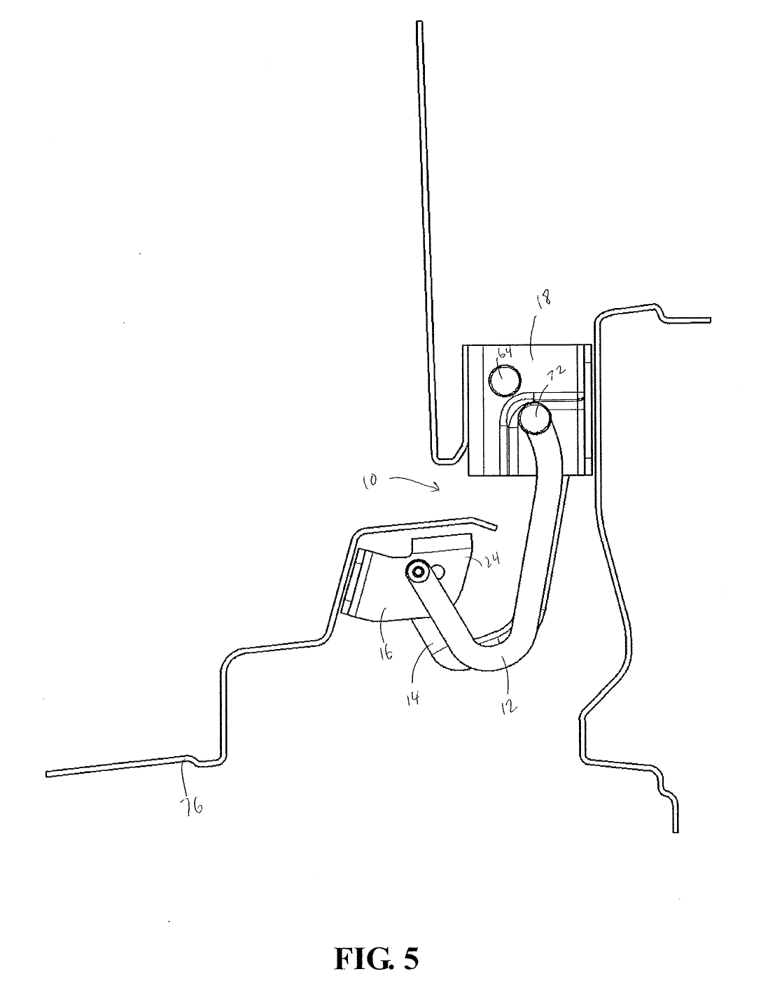

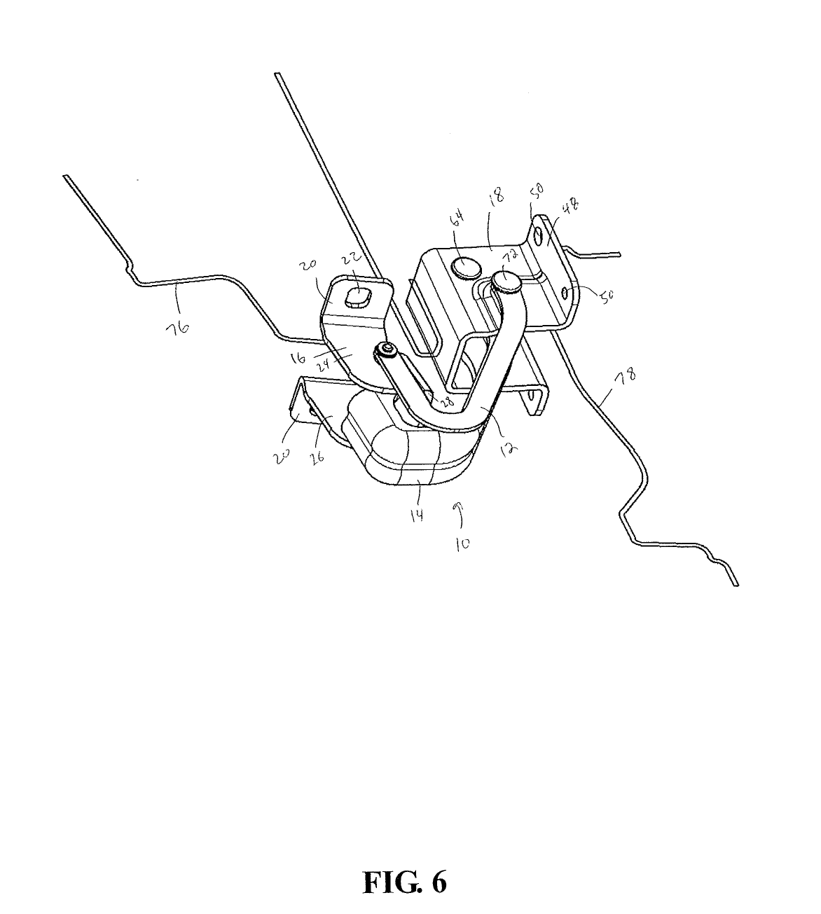

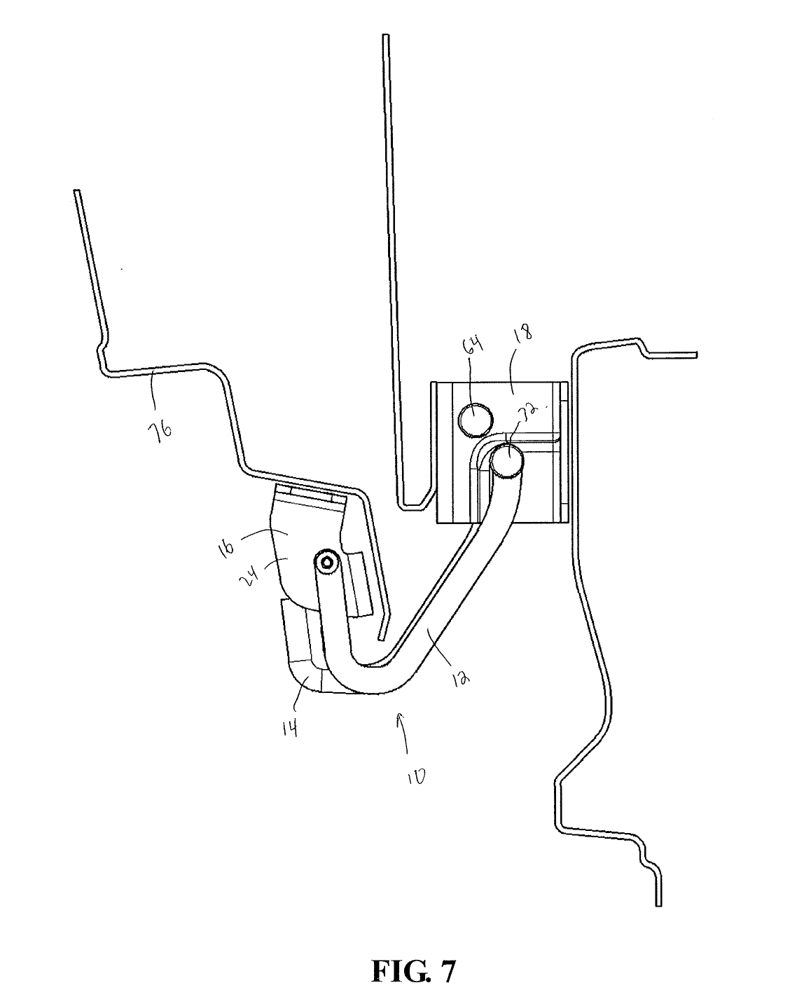

FIGS. 2 and 3 show the example hinge assembly 10 with the door bracket 16 attached to a door 76 and the body bracket 18 attached to a vehicle body 78. In FIGS. 2 and 3, the door is in a closed position. FIGS. 4 and 5 show the example hinge assembly 10 with the door 76 partially opened. As can be seen, the driver link 12 and load link 14 have pivoted so that the door bracket 16 could pivot with respect to the body bracket 18, which remains stationary. FIGS. 6 and 7 show the example hinge assembly 10 with the door 76 completely open. In this example, it can be seen that the door bracket 16 was allowed to continue pivoting to approximately 170 degrees due to rotation about the first end 30, 46 of the driver link 12 and load link 14. This allows the access to the interior compartment of the vehicle to be more easily accessed. As can be seen from the example hinge assembly 10 shown in these Figures, the hinge assembly 10 acts like a single functioning hinge. As the door 76 swings open, the driver link 12 is fixed in association with the load link 14. This association allows the hinge assembly 10 to rotate and keep constant orientation between each link 12, 14, which allows for a smooth and single opening motion.

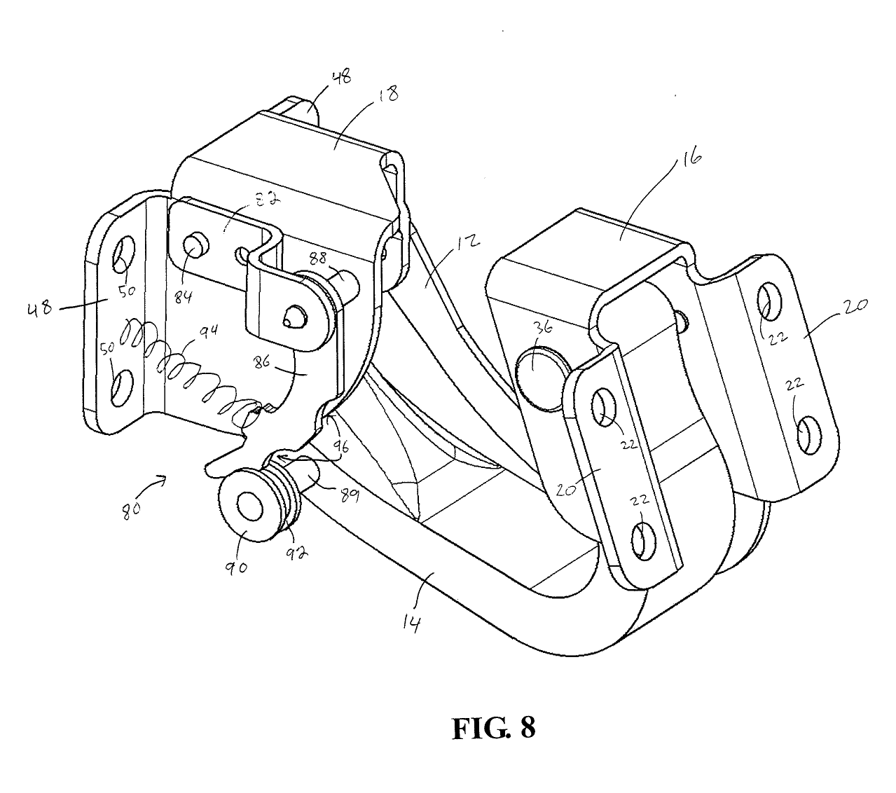

FIG. 8 shows an example embodiment of the hinge assembly 10 with an integral door check assembly 80. The door check assembly 80 may be used to maintain a desired position of the door 76 when the door is opened. For example, if the user wanted the door to be held open in a partially opened position, the door check assembly 80 would prevent the door from being shut on the user. Likewise, if the user wanted the door 76 to be maintained in a fully open position, the door check 80 could be used. In the example door check assembly 80 shown in FIG. 8, a bracket 82 for connecting the door check assembly 80 has a first end attached to the body bracket 18 with a pin 84. A second end of the bracket 82 extends transversely away and is connected to the body bracket 18 with a pin 88. A first end of a pawl 86 is pivotably coupled to the pin 88. Another pin 89 has a proximal end connected to the load link 14 and a distal end with a wheel 90. A groove 92 is defined in the wheel 90 that receives a portion of the pawl 86. A biasing member, such as a spring 94, may be provided to urge the pawl 86 toward the wheel 90. One or more notches 96 in the pawl 86 allow the hinge assembly 10 to maintain a position due to the biasing of the spring member 94 urging the pawl 86 against the wheel 90.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A vehicle door hinge assembly for pivotally coupling a vehicle door with a vehicle body, the hinge assembly comprising:
a door bracket attachable to a vehicle door;
a body bracket attachable to a vehicle body;
a load link having a first end pivotally coupled with the door bracket and a second end pivotally coupled with the body bracket;
a driver link having a first end pivotally coupled with the door bracket and a second end pivotally coupled with the body bracket;
wherein the load link is configured to structurally support substantially the entire weight of the vehicle door; and
wherein the hinge assembly is configured to pivot the door bracket up to approximately 170 degrees with respect to the body bracket.

2. The hinge assembly as recited in claim 1, wherein an axis about which the first end of the load link pivots is fixed with respect to an axis about which the first end of the driver link pivots.

3. The hinge assembly as recited in claim 2, wherein an axis about which the second end of the load link pivots is fixed with respect to an axis about which the second end of the driver link pivots.

4. The hinge assembly as recited in claim 3, wherein the first end of the load link and the first end of the driver link have a gooseneck shape.

5. The hinge assembly as recited in claim 4, wherein the first end of the load link has at least two points of pivotal connection with the door bracket.

6. The hinge assembly as recited in claim 5, wherein the second end of the load link has at least two points of pivotal connection with the body bracket.

7. The hinge assembly as recited in claim 6, wherein the axis about which the first end of the load link pivots is closer to the vehicle door than the axis about which the first end of the driver link pivots.

8. The hinge assembly as recited in claim 7, wherein the axis about which the second end of the driver link pivots is closer to the vehicle body than the axis about which the second end of the load link pivots.

9. A vehicle door hinge assembly for pivotally coupling a vehicle door with a vehicle body, the hinge assembly comprising:
a door bracket attachable to a vehicle door, wherein the door bracket includes a generally U-shaped portion with a first door bracket leg spaced apart from a second door bracket leg with both legs extending from a door bracket bridge member, wherein one or more flanges extend from the U-shaped portion of the door bracket for attachment to a vehicle door;
a body bracket attachable to a vehicle body, wherein the body bracket includes a generally U-shaped portion with a first body bracket leg spaced apart from a second body bracket leg with both legs extending from a body bracket bridge member, wherein one or more flanges extend from the U-shaped portion of the body bracket for attachment to a vehicle body;
a load link having a first end pivotally coupled with the first door bracket leg and the second door bracket leg of the door bracket and a second end pivotally coupled with the first body bracket leg and the second body bracket leg of the body bracket;
a driver link having a first end pivotally coupled with the first door bracket leg and a second end pivotally coupled with the first body bracket leg;
wherein the load link is configured to structurally support substantially the entire weight of the vehicle door; and
wherein the hinge assembly is configured to pivot the door bracket up to approximately 170 degrees with respect to the body bracket.

10. The hinge assembly as recited in claim 9, wherein at least a portion of the first end of the load link is interposed between the first door bracket leg and the second door bracket leg.

11. The hinge assembly as recited in claim 10, wherein at least a portion of the second end of the load link is interposed between the first body bracket leg and the second body bracket leg.

12. The hinge assembly as recited in claim 11, wherein the first door bracket leg includes a hole that is aligned with a hole in the second door bracket leg, the first end of the load link includes at least two spaced apart flanges with aligned openings that are aligned with the holes in the first door bracket leg and the second door bracket leg.

13. The hinge assembly as recited in claim 12, further comprising a pin extending through the holes in the first door bracket leg and the second door bracket leg and the openings in the flanges on the first end of the load link.

14. The hinge assembly as recited in claim 13, wherein the first end of the load link pivots with respect to the door bracket about the pin.

15. The hinge assembly as recited in claim 14, wherein the first body bracket leg includes a hole that is aligned with a hole in the second body bracket leg, the second end of the load link includes at least two spaced apart flanges with aligned openings that are aligned with the holes in the first body bracket leg and the second body bracket leg.

16. The hinge assembly as recited in claim 15, further comprising a pin extending through the holes in the first body bracket leg and the second body bracket leg and the openings in the flanges on the second end of the load link.

17. The hinge assembly as recited in claim 16, wherein the first end of the load link and the first end of the driver link have a gooseneck shape.

18. The hinge assembly as recited in claim 9, further comprising a door check assembly configured to hold the door bracket in a selected position with respect to the load link.

19. The hinge assembly as recited in claim 18, wherein the door check assembly includes a pawl pivotally attached to the door bracket and a wheel connected to the load link, further including a biasing member urging the pawl towards the wheel, wherein the biasing member is configured to maintain a position of the door bracket with respect to the load link due to the biasing of the biasing member urging the pawl against the wheel.

20. The hinge assembly as recited in claim 19, wherein the wheel includes a circumferential groove that receives the pawl, wherein the pawl includes one or more notches corresponding with selected positions in which to maintain the door bracket with respect to the load link.
